(19) United States
(12) Patent Application Publication
(10) Pub. No.: US 2026/0058908 A1
(43) Pub. Date: Feb. 26, 2026

(54) TRAFFIC SCHEDULING METHOD AND DEVICE FOR DISTRIBUTED STORAGE CLUSTER

(71) Applicant: Beijing Volcano Engine Technology Co., Ltd., Beijing (CN)

(72) Inventors: Yangcheng HE, Beijing (CN); Wenjun DING, Beijing (CN); Sibin LUO, Beijing (CN); Fan BAI, Beijing (CN)

(21) Appl. No.: 19/277,139

(22) Filed: Jul. 22, 2025

(30) Foreign Application Priority Data
Aug. 26, 2024 (CN) 202411179746.3

(51) Int. Cl. H04L 47/127; H04L 41/14; H04L 47/193; H04L 67/1097

(52) U.S. Cl. CPC H04L 47/127; H04L 41/145; H04L 47/193; H04L 67/1097

(57) ABSTRACT

Embodiments of the present disclosure provide a traffic scheduling method for a distributed storage cluster including: acquiring a write traffic corresponding to each of N historical periods; acquiring a write traffic proportion, a capacity increment and a load corresponding to each of the storage pools in each of the historical periods; predicting a write traffic prediction value of an (N+1)th new period based on the write traffic; generating a capacity increment prediction quantization model and a load prediction quantization model based on the write traffic, the write traffic proportion, the capacity increment and the load; and invoking the capacity increment prediction quantization model and the load prediction quantization model based on the write traffic prediction value to generate a target traffic scheduling policy of the (N+1)th new period, and controlling traffic scheduling of each resource pool based on a target scheduling proportion indicated by the target traffic scheduling policy.

### CROSS-REFERENCE TO RELATED APPLICATION(S)

This application claims priority to Chinese Application No. 202411179746.3 filed Aug. 26, 2024, the disclosure of which is incorporated herein by reference in its entirety.

### TECHNICAL FIELD

Embodiments of the present disclosure relate to the technical field of the distributed storage cluster, and in particular, to a traffic scheduling method and device for a distributed storage cluster.

### BACKGROUND

A distributed storage cluster can provide massive, secure, low-cost, highly reliable, and highly available object storage services by storing and invoking various unstructured data files such as texts, pictures, audios, and videos over a network. One distributed storage cluster is mounted with a plurality of storage pools. As time goes by, write capacities and loads on the plurality of storage pools may gradually become unbalanced. Therefore, in the distributed storage cluster, a traffic scheduling method between the plurality of storage pools is needed to ensure that the write capacities and loads of the plurality of storage pools are balanced.

In the prior art, a technician collects and analyzes write capacities and loads of a plurality of storage pools in a Tth period, and adjusts traffic write proportions of the plurality of storage pools in a (T+1) th period according to past manual experience, to expect the write capacities and loads of the plurality of storage pools to be balanced.

However, according to past manual experience, the accuracy of adjusting the traffic write proportions of the plurality of storage pools in the (T+1)th period is poor, and it may take a plurality of periods to balance the write capacities and loads of the plurality of storage pools. Therefore, the scheduling efficiency of the above traffic scheduling method is low.

### SUMMARY

Embodiments of the present disclosure provide a traffic scheduling method and device for a distributed storage cluster.

In a first aspect, an embodiment of the present disclosure provides a traffic scheduling method for a distributed storage cluster, including:
acquiring a write traffic corresponding to each of N historical periods in the distributed storage cluster, wherein the distributed storage cluster provides a storage service through a plurality of storage pools;
acquiring a write traffic proportion, a capacity increment and a load corresponding to each of the storage pools in the distributed storage cluster in each of the historical periods;
predicting a write traffic prediction value of an (N+1)th new period based on the write traffic corresponding to each of the historical periods;
generating a capacity increment prediction quantization model and a load prediction quantization model based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions; and
invoking the capacity increment prediction quantization model and the load prediction quantization model based on the write traffic prediction value of the (N+1)th new period, to generate a target traffic scheduling policy of the (N+1)th new period, and controlling traffic scheduling of each resource pool based on a target scheduling proportion indicated by the target traffic scheduling policy.

In a second aspect, an embodiment of the present disclosure provides a traffic scheduling device for a distributed storage cluster, including:
an acquiring unit, configured to acquire a write traffic corresponding to each of N historical periods in the distributed storage cluster, wherein the distributed storage cluster provides a storage service through a plurality of storage pools;
the acquiring unit is further configured to acquire a write traffic proportion, a capacity increment and a load corresponding to each of the storage pools in the distributed storage cluster in each of the historical periods;
a predicting unit, configured to predict a write traffic prediction value of an (N+1)th new period based on the write traffic corresponding to each of the historical periods;
a model generating unit, configured to generate a capacity increment prediction quantization model and a load prediction quantization model based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions; and
a scheduling unit, configured to invoke the capacity increment prediction quantization model and the load prediction quantization model based on the write traffic prediction value of the (N+1)th new period, to generate a target traffic scheduling policy of the (N+1)th new period, and controlling traffic scheduling of each resource pool based on a target scheduling proportion indicated by the target traffic scheduling policy.

In a third aspect, an embodiment of the present disclosure provides an electronic device, including: a processor and a memory;
wherein the memory stores computer-executable instructions; and
the processor executes the computer-executable instructions stored in the memory, to cause the at least one processor to execute the traffic scheduling method for the distributed storage cluster according to the first aspect and various possible designs of the first aspect.

In a fourth aspect, an embodiment of the present disclosure provides a computer-readable storage medium, wherein the computer-readable storage medium stores computer-executable instructions which, when executed by a processor, the traffic scheduling method for the distributed storage cluster according to the first aspect and various possible designs of the first aspect is implemented.

In a fifth aspect, an embodiment of the present disclosure provides a computer program product, including a computer program which, when executed by a processor, the traffic scheduling method for the distributed storage cluster according to the first aspect and various possible designs of the first aspect is implemented.

The traffic scheduling method and device for the distributed storage cluster provided in this embodiment include: acquiring a write traffic corresponding to each of N historical periods in the distributed storage cluster, wherein the distributed storage cluster provides a storage service through a plurality of storage pools; acquiring a write traffic proportion, a capacity increment and a load corresponding to each of the storage pools in the distributed storage cluster in each of the historical periods; predicting a write traffic prediction value of an (N+1)th new period based on the write traffic corresponding to each of the historical periods; generating a capacity increment prediction quantization model and a load prediction quantization model based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions; and invoking the capacity increment prediction quantization model and the load prediction quantization model based on the write traffic prediction value of the (N+1)th new period, to generate a target traffic scheduling policy of the (N+1)th new period, and controlling traffic scheduling of each resource pool based on a target scheduling proportion indicated by the target traffic scheduling policy, to enable the load and the capacity increment to meet a balance indicator.

### BRIEF DESCRIPTION OF THE DRAWINGS

In order to illustrate the technical solutions in the embodiments of the present disclosure or in the prior art more clearly, the following briefly introduces the drawings required for describing the embodiments or the prior art. Apparently, the drawings in the following description show some embodiments of the present disclosure, and a person of ordinary skill in the art can derive other drawings from these drawings without creative efforts.

FIG. 1 is a schematic diagram of an application scenario of a traffic scheduling method for a distributed storage cluster according to an embodiment of the present disclosure;

FIG. 2 is a first flowchart of a traffic scheduling method for a distributed storage cluster according to an embodiment of the present disclosure;

FIG. 3 is a first schematic diagram of a traffic scheduling method for a distributed storage cluster according to an embodiment of the present disclosure;

FIG. 4 is a second flowchart of a traffic scheduling method for a distributed storage cluster according to an embodiment of the present disclosure;

FIG. 5 is a schematic diagram of a structure of a traffic scheduling device for a distributed storage cluster according to an embodiment of the present disclosure; and

FIG. 6 is a schematic diagram of a structure of an electronic device according to an embodiment of the present disclosure.

### DETAILED DESCRIPTION OF EMBODIMENTS

In order to make the objectives, technical solutions, and advantages of the embodiments of the present disclosure clearer, the following clearly and comprehensively describes the technical solutions in the embodiments of the present disclosure with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

Firstly, the background art and some terms involved in this application are explained.

Distributed storage cluster: A distributed storage cluster may provide massive, secure, low-cost, highly reliable, and highly available object storage services by storing and invoking various unstructured data files such as texts, pictures, audios, and videos over a network. The distributed storage cluster may include a plurality of storage pools.

Stock capacity of a storage pool: a capacity that has been used in the storage pool, that is, the total size of all files in the storage pool.

Write capacity of a storage pool: remaining available space in the storage pool, that is, the capacity in which a user can still add a file to the storage pool. The write capacity is usually calculated by subtracting the stock capacity from the total capacity. For example, if the total capacity of a storage pool is 100 GB and the stock capacity is 50 GB, the write capacity is 50 GB.

Capacity increment of a storage pool: a capacity of adding a file to the storage pool. A stock capacity of the storage pool in an (N+1)th new period is equal to a sum of a historical stock capacity of the storage pool in an Nth period and a capacity increment of the storage pool in the (N+1)th new period. For example, the total capacity of the storage pool is 100 GB, the historical stock capacity of the storage pool in the Nth period is 50 GB, and the capacity increment is 5 GB. Therefore, the stock capacity of the storage pool in the (N+1)th new period is 55 GB.

A distributed storage cluster can provide massive, secure, low-cost, highly reliable, and highly available object storage services by storing and invoking various unstructured data files such as texts, pictures, audios, and videos over a network. One distributed storage cluster is mounted with a plurality of storage pools. As time goes by, write capacities and loads on the plurality of storage pools may gradually become unbalanced. Therefore, in the distributed storage cluster, a traffic scheduling solution between the plurality of storage pools is needed to ensure that the write capacities and loads of the plurality of storage pools are balanced.

Reasons why the write capacities and loads on the plurality of storage pools may gradually become unbalanced over time include the following.
1. Expand a new storage pool: when an overall capacity of the distributed storage cluster is insufficient, a new storage pool may be expanded. A write capacity of the newly expanded storage pool is much larger than write capacities of other storage pools.
2. Take an old storage pool offline: some storage pools need to be taken offline for various reasons, and data on the storage pool may be migrated to another storage pool, which may also cause read/write imbalance of another storage pool.
3. Uneven user writing: after a user writes data, a stock capacity or a write capacity of different storage pools may be unbalanced due to reasons such as data scheduling/different data lifecycle differences.

In the prior art, a technician collects and analyzes write capacities and loads of a plurality of storage pools in a Tth period, and adjusts traffic write proportions of the plurality of storage pools in a (T+1) th period according to past manual experience (that is, the write traffic proportion in the embodiment shown in FIG. 2), so as to expect the write capacities and loads of the plurality of storage pools to be balanced.

However, according to past manual experience, the accuracy of adjusting the traffic write proportions of the plurality of storage pools in the (T+1)th period is poor, and it may take a plurality of periods to balance the write capacities and loads of the plurality of storage pools. Therefore, the scheduling efficiency of the above traffic scheduling method is low.

It can be seen that how to quickly balance write capacities and loads of a plurality of storage pools to improve scheduling efficiency of a distributed storage cluster is a technical problem that needs to be solved urgently.

In view of the technical problem in the prior art, a technical concept of the inventor is as follows: According to a relationship between a read/write load/capacity and a traffic scheduling proportion, predicting, by using a specific AI (Artificial Intelligence) model, an impact of different scheduling proportions on capacity/load balance, so as to intelligently select an optimal solution from a plurality of traffic scheduling proportions.

Correspondingly, specific steps may include: firstly, acquiring a write traffic corresponding to each of N historical periods in the distributed storage cluster, wherein the distributed storage cluster provides a storage service through a plurality of storage pools; and acquiring a write traffic proportion, a capacity increment and a load corresponding to each of the storage pools in the distributed storage cluster in each of the historical periods. Then, predicting a write traffic prediction value of an (N+1)th new period based on the write traffic corresponding to each of the historical periods; and generating a capacity increment prediction quantization model and a load prediction quantization model based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions. Finally, invoking the capacity increment prediction quantization model and the load prediction quantization model based on the write traffic prediction value of the (N+1)th new period, to generate a target traffic scheduling policy of the (N+1)th new period, and controlling traffic scheduling of each resource pool based on a target scheduling proportion indicated by the target traffic scheduling policy, to enable the load and the capacity increment to meet a balance indicator.

In this technical solution, the write traffic prediction value of the (N+1)th new period is first predicted based on the write traffic corresponding to each of the historical periods, and then the capacity increments and the loads of the resource pool caused by different scheduling proportions are predicted by using the capacity increment prediction quantization model and the load prediction quantization model. Further, the target traffic scheduling policy of the (N+1)th new period is generated based on an impact of the different scheduling proportions on capacity and load balance, and the capacity and the load of the plurality of storage pools quickly reach the balance indicator by using the target traffic scheduling solution. Therefore, the scheduling efficiency of the distributed storage cluster is improved.

The following explains an application scenario of the embodiments of the present disclosure.

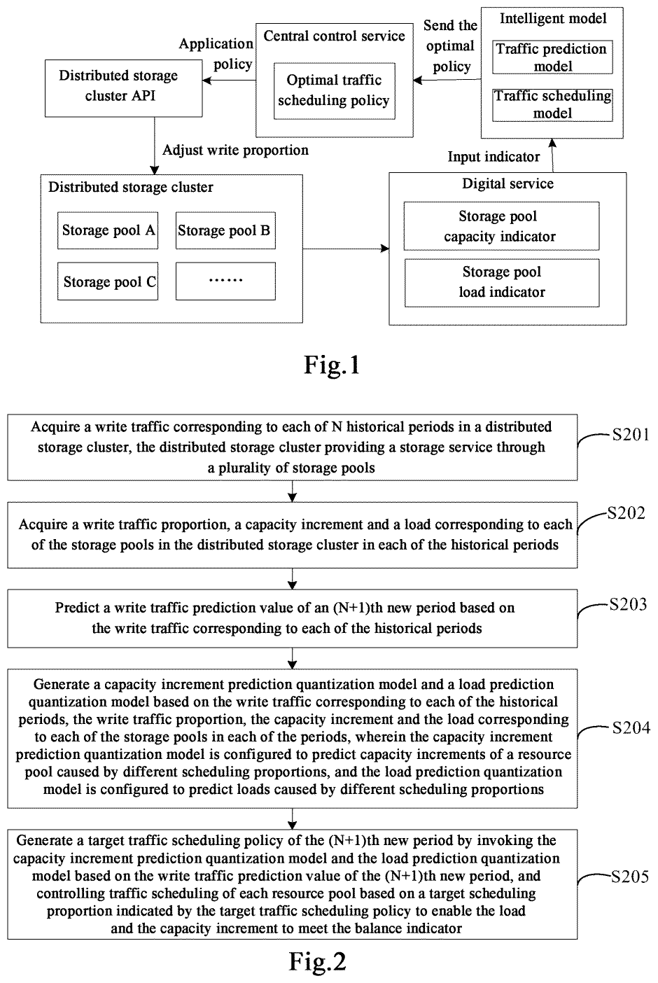

The traffic scheduling method for the distributed storage cluster provided in this embodiment of the present disclosure may be applied to various traffic scheduling scenarios of the distributed storage cluster. FIG. 1 is a schematic diagram of an application scenario of a traffic scheduling method for a distributed storage cluster according to an embodiment of the present disclosure. As shown in FIG. 1, an API (Application Programming Interface) of the distributed storage cluster may apply a traffic scheduling policy to write write traffic of the distributed storage cluster into each of storage pools based on a write proportion of each of the storage pools in a corresponding policy.

The storage pool is an application entity of the write traffic scheduling policy, and different storage pools may carry the write traffic based on different write proportions. A digital service may acquire a capacity indicator and a load indicator of each of the storage pools, and automatically construct a capacity/load indicator of the storage pool dimension. An intelligent model module may intelligently predict future write traffic by using various AI models (a traffic prediction model and a traffic scheduling model in FIG. 1), and intelligently calculate an optimal scheduling method. A central control service module may invoke an interface of the API of the distributed storage cluster based on an optimal policy recommended by the intelligent model, and the API of the distributed storage cluster applies the recommended optimal policy.

FIG. 2 is a first flowchart of a traffic scheduling method for a distributed storage cluster according to an embodiment of the present disclosure. Through such method, write capacities and loads of a plurality of storage pools are balanced quickly and scheduling efficiency of the distributed storage cluster is improved. In this embodiment of the present disclosure, the execution body of the scheduling method may be a terminal or a server. As shown in FIG. 2, the traffic scheduling method may include the following steps.

S201: a write traffic corresponding to each of N historical periods in the distributed storage cluster is acquired, wherein the distributed storage cluster provides a storage service through a plurality of storage pools.

In this embodiment of the present disclosure, the distributed storage cluster may include a plurality of storage pools, wherein the number of the plurality of storage pools may be set based on a requirement. N is a positive integer. In this embodiment of the present disclosure, a value of N and a period duration are not specifically limited. Optionally, the value of N may be 10, 20, 30, or the like, and the period duration may be 6 hours, 12 hours, one day, or the like.

In S202, a write traffic proportion, a capacity increment and a load corresponding to each of the storage pools in the distributed storage cluster in each of the historical periods are acquired.

The write traffic proportion is used to represent write traffic allocated to each of the storage pools. The capacity increment is used to represent a capacity newly added to each of the storage pools. The load may include one or more of a read request load, a write request load, and a query request load. Optionally, the load represents the number of requests to be processed in the storage pool. Correspondingly, the load of the storage pool includes a sum of the number of read requests to be processed, the number of write requests to be processed, and the number of query requests to be processed.

For example, the distributed storage cluster includes a storage pool A, a storage pool B, and a storage pool C. Total write traffic of the distributed storage cluster in the Nth period is 10 GB. The write traffic proportion may be storage pool A (30%), storage pool B (30%), and storage pool C (40%). In this case, the write traffic allocated to the storage pool A is 3 GB, and the capacity increment is 3 GB. The write traffic allocated to the storage pool B is 3 GB, and the capacity increment is 3 GB. The write traffic allocated to the storage pool C is 4 GB, and the capacity increment is 4 GB.

In S203, a write traffic prediction value of an (N+1)th new period is predicted based on the write traffic corresponding to each of the historical periods.

In some embodiments, the write traffic of the (N+1)th new period has a strong relationship with the write traffic of the N historical periods, and the write traffic prediction value of the (N+1)th new period may be predicted by a trend prediction model. Correspondingly, this step may include predicting the write traffic prediction value of the (N+1)th new period by the trend prediction model and based on the write traffic corresponding to each of the historical periods.

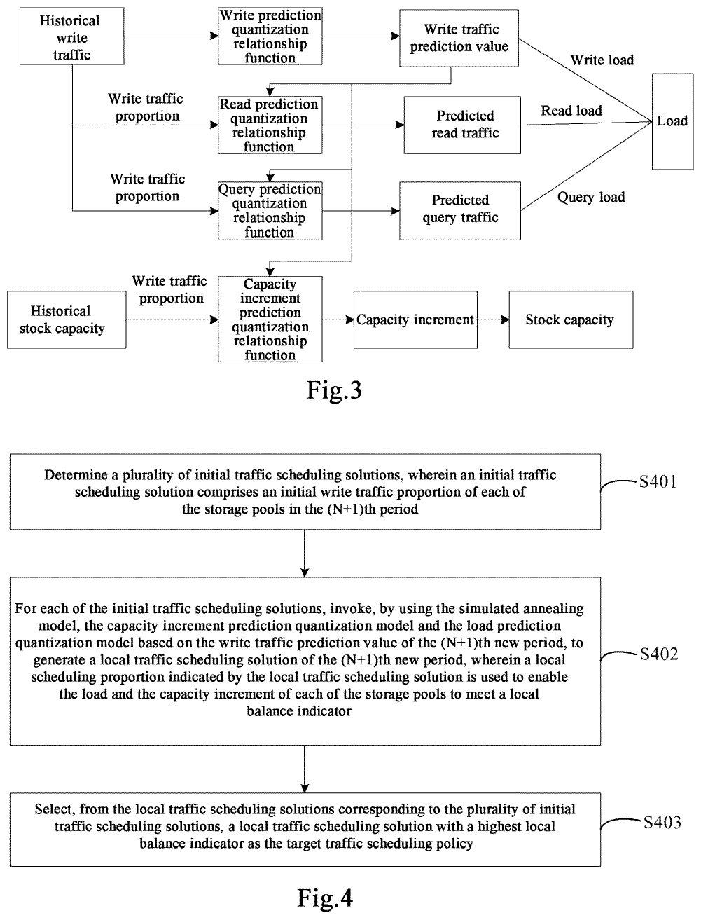

The trend prediction model includes a prophet model or a long-short term memory (LSTM) model. Exemplarily, as shown in FIG. 3, the trend prediction model includes a write prediction quantization relationship function.

Here, because the write traffic of the (N+1)th new period has a strong relationship with the write traffic of the N historical periods, the accuracy of the write traffic prediction value of the (N+1) th new period may be improved by using the trend prediction model.

In S204, a capacity increment prediction quantization model and a load prediction quantization model are generated based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions. The scheduling proportion is the write traffic proportion corresponding to each of the storage pools.

In some embodiments, this step may include: generating the capacity increment prediction quantization model based on the write traffic corresponding to each of the historical periods, the write traffic proportion and the capacity increment corresponding to each of the storage pools in each of the periods; and generating the load prediction quantization model based on the write traffic corresponding to each of the historical periods, the write traffic proportion and the load corresponding to each of the storage pools in each of the periods.

Exemplarily, as shown in FIG. 3, the capacity increment prediction quantization model includes a capacity increment prediction quantization relationship function.

Optionally, the load includes one or more of a read request load, a write request load, and a query request load. Exemplarily, as shown in FIG. 3, the load includes a read request load (which may be represented as read IOPS), a write request load (which may be represented as write IOPS), and a query request load (which may be represented as QPS).

In this case, the load prediction quantization model may include a write prediction quantization relationship function between the write traffic, the write traffic proportion, and the write request load; a read prediction quantization relationship function between the write traffic, the write traffic proportion, and the read request load; and a query prediction quantization relationship function between the write traffic, the write traffic proportion, and the query request load.

In S205, the capacity increment prediction quantization model and the load prediction quantization model are invoked based on the write traffic prediction value of the (N+1) th new period to generate the target traffic scheduling policy of the (N+1)th new period, and traffic scheduling of each resource pool is controlled based on the target scheduling proportion indicated by the target traffic scheduling policy, to enable the load and the capacity increment to meet the balance indicator.

In some embodiments, the capacity increment prediction quantization model and the load prediction quantization model are invoked based on the write traffic prediction value of the (N+1)th new period, to generate the target traffic scheduling policy of the (N+1)th new period, including: invoking, by using a simulated annealing model, the capacity increment prediction quantization model and the load prediction quantization model based on the write traffic prediction value of the (N+1)th new period, to generate the target traffic scheduling policy of the (N+1)th new period.

It is to be noted that the capacity increment of the storage pool represents a capacity of adding a file to the storage pool. The stock capacity of the storage pool in the (N+1)th new period is equal to a sum of the historical stock capacity of the storage pool in the Nth period and the capacity increment of the storage pool in the (N+1)th new period.

For example, a total capacity of the storage pool A is 100 GB, the historical stock capacity of the storage pool A in the Nth period is 50 GB, the capacity increment is 5 GB, and the stock capacity of the storage pool A in the (N+1)th new period is 55 GB. Therefore, a write capacity of the storage pool A in the (N+1)th new period is 45 GB.

The capacity increment is enabled to meet the balance indicator, representing that a stock capacity difference between the storage pools is less than a preset capacity threshold, or a write capacity difference between the storage pools is less than a preset capacity threshold.

In some embodiments, the load and the capacity increment are enabled to meet the balance indicator, representing that a load difference between the storage pools is less than a preset load threshold, and the stock capacity difference between the storage pools is less than the preset capacity threshold. The load represents the number of requests to be processed in the storage pool. The load difference between the storage pools represents a difference between the numbers of requests to be processed.

In some other embodiments, the load and the capacity increment are enabled to meet the balance indicator, representing that the load difference between the storage pools is less than the preset load threshold, and the write capacity difference between the storage pools is less than the preset capacity threshold.

In this embodiment of the present disclosure, values of the preset load threshold and the preset capacity threshold are not specifically limited, and may be set and modified based on a requirement. Optionally, the preset load threshold (that is, the difference between the numbers of requests to be processed) is 100, and the preset capacity threshold is 10 GB.

This embodiment of the present disclosure provides a traffic scheduling method for a distributed storage cluster. Firstly, a write traffic corresponding to each of N historical periods in the distributed storage cluster is acquired, wherein the distributed storage cluster provides a storage service through a plurality of storage pools; and a write traffic proportion, a capacity increment and a load corresponding to each of the storage pools in the distributed storage cluster in each of the historical periods are acquired. Then, a write traffic prediction value of an (N+1)th new period is predicted based on the write traffic corresponding to each of the historical periods; and a capacity increment prediction quantization model and a load prediction quantization model are generated based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions. Finally, the capacity increment prediction quantization model and the load prediction quantization model are invoked based on the write traffic prediction value of the (N+1)th new period, to generate a target traffic scheduling policy of the (N+1)th new period, and traffic scheduling of each resource pool is controlled based on a target scheduling proportion indicated by the target traffic scheduling policy, to enable the load and the capacity increment to meet a balance indicator. In this technical solution, the write traffic prediction value of the (N+1)th new period is first predicted based on the write traffic corresponding to each of the historical periods, and then the capacity increments and the loads of the resource pool caused by different scheduling proportions are predicted by using the capacity increment prediction quantization model and the load prediction quantization model. Further, the target traffic scheduling policy of the (N+1)th new period is generated based on an impact of the different scheduling proportions on capacity and load balance, and the capacity and the load of the plurality of storage pools quickly reach the balance indicator by using the target traffic scheduling solution. Therefore, the scheduling efficiency of the distributed storage cluster is improved.

FIG. 4 is a second flowchart of a traffic scheduling method for a distributed storage cluster according to an embodiment of the present disclosure. In this embodiment of the present disclosure, a method for invoking the capacity increment prediction quantization model and the load prediction quantization model based on the write traffic prediction value of the (N+1)th new period to generate the target traffic scheduling policy of the (N+1)th new period in S205 is described in detail. As shown in FIG. 4, the method includes the following steps.

S401: Determine a plurality of initial traffic scheduling solutions, whereinin an initial traffic scheduling solution includes an initial write traffic proportion of each of the storage pools in the (N+1)th period.

In this embodiment of the present disclosure, the number of the plurality of initial traffic scheduling solutions is not specifically limited.

Optionally, initial write traffic proportions of the respective storage pools in the (N+1) th period in different initial traffic scheduling solutions greatly differ.

In some embodiments, there is at least one storage pool whose difference between initial write traffic proportions in the plurality of initial traffic scheduling solutions is greater than a preset proportion threshold. In the embodiments of the present disclosure, a value of the preset proportion threshold is not specifically limited. Exemplarily, the preset proportion threshold may be 10%, 20%, 30%, or the like.

Exemplarily, the distributed storage cluster includes a storage pool A, a storage pool B, and a storage pool C. The number of the plurality of initial traffic scheduling solutions is 2. An initial write traffic proportion of each of the storage pools in the (N+1)th period in an initial traffic scheduling solution 1 is storage pool A (10%), storage pool B (20%), and storage pool C (70%). An initial write traffic proportion of each of the storage pools in the (N+1)th period in an initial traffic scheduling solution 2 is storage pool A (50%), storage pool B (20%), and storage pool C (30%). The preset proportion threshold may be 30%. In this case, a difference between the initial write traffic proportion of the storage pool A in the initial traffic scheduling solution 1 and the initial write traffic proportion of the storage pool A in the initial traffic scheduling solution 2 (40%) is greater than the preset proportion threshold (30%).

In S402, for each of the initial traffic scheduling solutions, the capacity increment prediction quantization model and the load prediction quantization model are invoked by using the simulated annealing model based on the write traffic prediction value of the (N+1)th new period, to generate a local traffic scheduling solution of the (N+1)th new period, wherein a local scheduling proportion indicated by the local traffic scheduling solution is used to enable the load and the capacity increment of each of the storage pools to meet a local balance indicator.

In some embodiments, this step may include the following steps (1) to (3).
(1) For each of the initial traffic scheduling solutions, the initial write traffic proportion of each of the storage pools in the (N+1)th period in the initial traffic scheduling solution is adjusted by using the simulated annealing model, to acquire a plurality of simulated write traffic proportions of each of the storage pools in the (N+1)th period.

In this step, an adjustment parameter of each of the initial write traffic proportions is not specifically limited. For example, the adjustment parameter is 1%, 2%, 3%, or the like. The number of the plurality of simulated write traffic proportions is a preset number. For example, the number may be 10, 20, 30, or the like.

Exemplarily, the distributed storage cluster includes a storage pool A and a storage pool B. The initial write traffic proportion is storage pool A (70%) and storage pool B (30%). The adjustment parameter is 1%, and the preset number is 10. In this case, the plurality of simulated write traffic proportions are storage pool A (71%) and storage pool B (29%); storage pool A (72%) and storage pool B (28%); and so on; storage pool A (80%) and storage pool B (20%).
(2) For each of the simulated write traffic proportions, the capacity increment prediction quantization model is invoked based on the simulated write traffic proportion and the write traffic prediction value, to predict the capacity increment of each of the storage pools in the (N+1) th period; and the load prediction quantization model is invoked based on the simulated write traffic proportion and the write traffic prediction value, to predict the load of each of the storage pools in the (N+1)th period.

Exemplarily, the distributed storage cluster includes a storage pool A and a storage pool B. The write traffic prediction value of the (N+1)th new period is 10 GB. The simulated write traffic proportion is storage pool A (70%) and storage pool B (30%).

In this case, the capacity increment prediction quantization model is invoked based on the simulated write traffic proportion and the write traffic prediction value, to predict that the capacity increment of the storage pool A in the (N+1)th period is 7 GB, and the capacity increment of the storage pool B in the (N+1)th period is 3 GB.

The load prediction quantization model is invoked based on the simulated write traffic proportion and the write traffic prediction value, to predict that the load of the storage pool A in the (N+1) th period is 70 read/write requests per second, and the load of the storage pool B in the (N+1)th period is 30 read/write requests per second.
(3) A first target write traffic proportion is determined from the plurality of simulated write traffic proportions, wherein the first target write traffic proportion is a simulated write traffic proportion corresponding to a case that the capacity increment and the load of each of the storage pools in the (N+1)th period reach a local balance state.

In this embodiment of the present disclosure, the capacity increment and the load of each of the storage pools reaching the local balance state represents that capacity differences between the storage pools are the smallest, and load differences between the storage pools are the smallest. Optionally, the capacity differences between the storage pools being the smallest represents that a stock capacity difference between the storage pools is the smallest, or a write capacity difference between the storage pools is the smallest.

Optionally, as shown in FIG. 3, the capacity differences between the storage pools being the smallest represents that the stock capacity difference between the storage pools is the smallest. In this case, the stock capacity of the storage pool in the (N+1)th period is equal to a sum of the historical stock capacity and the capacity increment of the storage pool in the (N+1)th period. In this case, for each of the storage pools, the capacity increment of the storage pool is determined in (2), and then the stock capacity of the storage pool may be determined based on the sum of the historical stock capacity and the capacity increment.

It is to be noted that values of the plurality of simulated write traffic proportions are obtained by adjusting the initial write traffic proportion. Therefore, the values of the plurality of simulated write traffic proportions are close to the initial write traffic proportion. In this case, a local optimal balance state may be determined based on the plurality of simulated write traffic proportions obtained through adjustment.

In S403, a local traffic scheduling solution with a highest local balance indicator is selected from the local traffic scheduling solutions corresponding to the plurality of initial traffic scheduling solutions, and the selected local traffic scheduling solution is used as the target traffic scheduling policy.

In this embodiment of the present disclosure, the local balance indicator includes a stock capacity difference between the storage pools and/or a load difference between the storage pools. It is to be noted that the smaller the stock capacity difference between the storage pools and/or the load difference between the storage pools, the higher the local balance indicator.

In some embodiments, this step may include: selecting, from the local optimal traffic scheduling solutions corresponding to the plurality of initial traffic scheduling solutions, a local traffic scheduling solution with a smallest stock capacity difference and a smallest load difference between the storage pools as the target traffic scheduling policy.

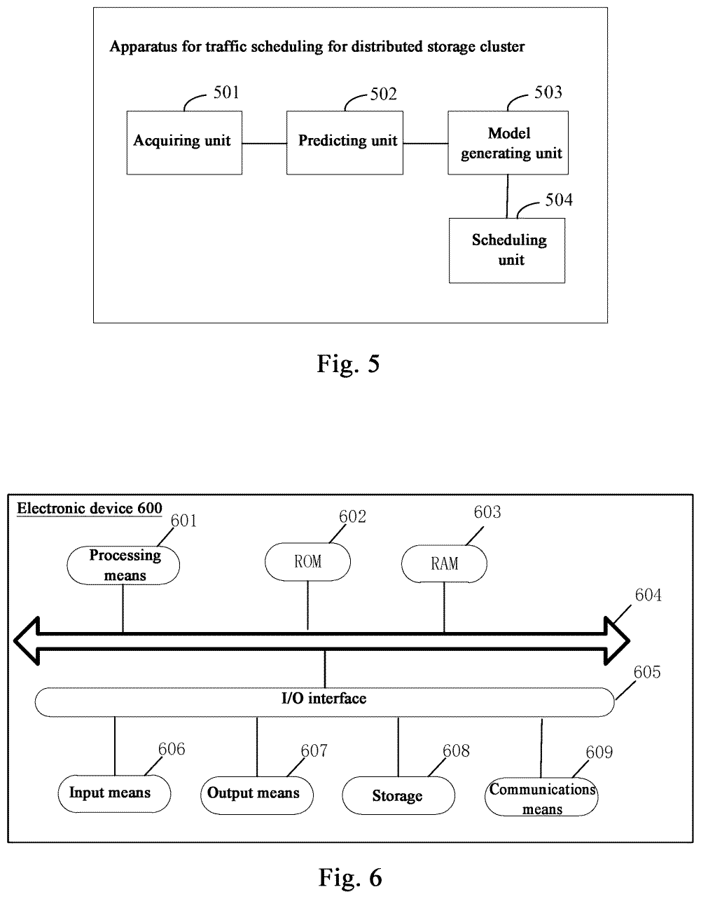

FIG. 5 is a schematic diagram of a structure of a traffic scheduling device for a distributed storage cluster according to an embodiment of the present disclosure. As shown in FIG. 5, the traffic scheduling device for the distributed storage cluster includes:
an acquiring unit 501, configured to acquire a write traffic corresponding to each of N historical periods in the distributed storage cluster, wherein the distributed storage cluster provides a storage service through a plurality of storage pools;
the acquiring unit 501 is further configured to acquire a write traffic proportion, a capacity increment and a load corresponding to each of the storage pools in the distributed storage cluster in each of the historical periods;
a predicting unit 502, configured to predict a write traffic prediction value of an (N+1) th new period based on the write traffic corresponding to each of the historical periods;
a model generating unit 503, configured to generate a capacity increment prediction quantization model and a load prediction quantization model based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions; and
a scheduling unit 504, configured to invoke the capacity increment prediction quantization model and the load prediction quantization model based on the write traffic prediction value of the (N+1) th new period, to generate a target traffic scheduling policy of the (N+1)th new period, and controlling traffic scheduling of each resource pool based on a target scheduling proportion indicated by the target traffic scheduling policy, to enable the load and the capacity increment to meet a balance indicator.

According to one or more embodiments of the present disclosure, the predicting unit 502, configured to predict the write traffic prediction value of the (N+1)th new period based on the write traffic corresponding to each of the historical periods, includes: predicting the write traffic prediction value of the (N+1)th new period by a trend prediction model and based on the write traffic corresponding to each of the historical periods, wherein the trend prediction model includes a prophet model or a long-short term memory (LSTM) model.

According to one or more embodiments of the present disclosure, the scheduling unit 504, configured to invoke the capacity increment prediction quantization model and the load prediction quantization model based on the write traffic prediction value of the (N+1)th new period, to generate the target traffic scheduling policy of the (N+1)th new period, includes: invoking, by using a simulated annealing model, the capacity increment prediction quantization model and the load prediction quantization model based on the write traffic prediction value of the (N+1)th new period, to generate the target traffic scheduling policy of the (N+1)th new period.

According to one or more embodiments of the present disclosure, the scheduling unit 504 is further configured to: determine a plurality of initial traffic scheduling solutions, whereinin an initial traffic scheduling solution includes an initial write traffic proportion of each of the storage pools in the (N+1)th period; for each of the initial traffic scheduling solutions, invoke the capacity increment prediction quantization model and the load prediction quantization model by using a simulated annealing model based on the write traffic prediction value of the (N+1)th new period, to generate a local traffic scheduling solution of the (N+1)th new period, wherein a local scheduling proportion indicated by the local traffic scheduling solution is used to enable the load and the capacity increment of each of the storage pools to meet a local balance indicator; and select a local traffic scheduling solution with a highest local balance indicator from the local traffic scheduling solutions corresponding to the plurality of initial traffic scheduling solutions as the target traffic scheduling policy.

According to one or more embodiments of the present disclosure, the scheduling unit 504 is further configured to: for each of the initial traffic scheduling solutions, adjust the initial write traffic proportion of each of the storage pools in the (N+1)th period in the initial traffic scheduling solution by using the simulated annealing model, to acquire the plurality of simulated write traffic proportions of each of the storage pools in the (N+1)th period; for each of the simulated write traffic proportions, invoke the capacity increment prediction quantization model based on the simulated write traffic proportion and the write traffic prediction value, to predict the capacity increment of each of the storage pools in the (N+1)th period; and invoke the load prediction quantization model based on the simulated write traffic proportion and the write traffic prediction value, to predict the load of each of the storage pools in the (N+1) th period; and determine the first target write traffic proportion from the plurality of simulated write traffic proportions, wherein the first target write traffic proportion is the simulated write traffic proportion corresponding to the case wherein the capacity increment and the load of each of the storage pools in the (N+1)th period reach the local balance state.

According to one or more embodiments of the present disclosure, the model generating unit 503 is configured to generate the capacity increment prediction quantization model and the load prediction quantization model based on the write traffic corresponding to each of the historical periods, the write traffic proportion, the capacity increment and the load corresponding to each of the storage pools in each of the periods, and includes: generating the capacity increment prediction quantization model based on the write traffic corresponding to each of the historical periods, the write traffic proportion and the capacity increment corresponding to each of the storage pools in each of the periods; and generating the load prediction quantization model based on the write traffic corresponding to each of the historical periods, the write traffic proportion and the load corresponding to each of the storage pools in each of the periods.

According to one or more embodiments of the present disclosure, the load includes one or more of a read request load, a write request load, and a query request load.

Reference is made to FIG. 6, which illustrates a schematic diagram of a structure of an electronic device 600 suitable for implementing the embodiments of the present disclosure. The electronic device 600 may be a terminal device or a server. The terminal device may include, but is not limited to, a mobile terminal such as a mobile phone, a notebook computer, a digital broadcast receiver, a personal digital assistant (abbreviated as PDA), a tablet computer, a portable media player (abbreviated as PMP), and an in-vehicle terminal (such as an in-vehicle navigation terminal), and a stationary terminal such as a digital TV and a desktop computer. The electronic device shown in FIG. 6 is merely an example, and shall not impose any limitation to the function and scope of use of the embodiments of the present disclosure.

As shown in FIG. 6, the electronic device 600 may include a processing means (such as a central processing unit and a graphics processor) 601. The processing means 601 may perform various appropriate actions and processing according to a program stored in a read-only memory (abbreviated as ROM) 602 or a program loaded from a storage 608 into a random access memory (abbreviated as RAM) 603. The RAM 603 further stores various programs and data required for the operation of the electronic device 600. The processing means 601, the ROM 602, and the RAM 603 are connected to each other through a bus 604. An input/output (I/O) interface 605 is also connected to the bus 604.

Generally, the following means may be connected to the I/O interface 605: an input means 606 including, for example, a touchscreen, a touchpad, a keyboard, a mouse, a camera, a microphone, an accelerometer, a gyroscope, and the like; an output means 607 including, for example, a liquid crystal display (abbreviated as LCD), a speaker, a vibrator, and the like; a storage 608 including, for example, a magnetic tape, a hard disk, and the like; and a communication means 609. The communication means 609 may allow the electronic device 600 to perform wireless or wired communication with another device to exchange data. Although FIG. 6 shows the electronic device 600 having various means, it is to be understood that not all of the illustrated means are necessarily implemented or included. Alternatively, more or fewer means may be implemented or included.

In particular, according to the embodiments of the present disclosure, the process described above with reference to the flowchart may be implemented as a computer software program. For example, an embodiment of the present disclosure includes a computer program product, wherein the computer program product includes a computer program carried on a computer-readable medium, and the computer program includes program code for executing the method shown in the flowchart. In such an embodiment, the computer program may be downloaded and installed from a network through the communication 609, or installed from the storage 608, or installed from the ROM 602. When the computer program is executed by the processing means 601, the above functions defined in the methods of the embodiments of the present disclosure are implemented.

It is to be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in baseband or as a part of a carrier wave, wherein computer-readable program code is carried in the data signal. The data signal propagated in this manner may be in various forms, including, but not limited to, an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with the instruction execution system, apparatus, or device. The program code contained in the computer-readable medium may be transmitted by using any suitable medium, including, but not limited to, an electric wire, an optical cable, a radio frequency (RF), or any suitable combination thereof.

The above computer-readable medium may be included in the above electronic device, or may also exist alone without being assembled into the electronic device.

The above computer-readable medium carries one or more programs, and the electronic device is caused to perform the method shown in the above embodiments when the one or more programs are executed by the electronic device.

The computer program codes for performing the operations in the present disclosure may be written in one or more programming languages or a combination thereof. The above programming languages include object-oriented programming languages such as Java, Smalltalk, and C++, and further include conventional procedural programming languages such as “C” programming language or similar programming languages. The program code may be executed entirely on a computer of a user, partly on the computer of the user, as a stand-alone software package, partly on the computer of the user and partly on a remote computer, or entirely on the remote computer or server. In the scenario related to the remote computer, the remote computer may be connected to the computer of the user through any type of network, including a Local Area Network (abbreviated as LAN) or a Wide Area Network (abbreviated as WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowchart or block diagram may represent a module, a program segment, or a part of codes, and the module, the program segment, or the part of codes contains one or more executable instructions for implementing specified logical functions. It should also be noted that in some alternative implementations, the functions marked in the blocks may also occur in an order different from those marked in the drawings. For example, two blocks shown in succession may, in fact, can be executed substantially concurrently, or the two blocks may sometimes be executed in a reverse order, depending on the functions involved. It should also be noted that each block of the block diagrams and/or flowcharts and a combination of blocks in the block diagrams and/or flowcharts may be implemented by a dedicated hardware-based system that performs specified functions or operations, or may also be implemented by a combination of dedicated hardware and computer instructions.

The described units involved in the embodiments of the present disclosure may be implemented in software or hardware. The name of the unit does not constitute a limitation of the unit itself under certain circumstances. For example, a first acquiring unit may also be described as “a unit for acquiring at least two Internet protocol addresses”.

The functions described herein above may be performed, at least in part, by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

In a first aspect, according to one or more embodiments of the present disclosure, a traffic scheduling method for a distributed storage cluster is provided, including: acquiring a write traffic corresponding to each of N historical periods in the distributed storage cluster, wherein the distributed storage cluster provides a storage service through a plurality of storage pools; acquiring a write traffic proportion, a capacity increment and a load corresponding to each of the storage pools in the distributed storage cluster in each of the historical periods; predicting a write traffic prediction value of an (N+1)th new period based on the write traffic corresponding to each of the historical periods; generating a capacity increment prediction quantization model and a load prediction quantization model based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions; and invoking the capacity increment prediction quantization model and the load prediction quantization model based on the write traffic prediction value of the (N+1)th new period, to generate a target traffic scheduling policy of the (N+1) th new period, and controlling traffic scheduling of each resource pool based on a target scheduling proportion indicated by the target traffic scheduling policy, to enable the load and the capacity increment to meet a balance indicator.

According to one or more embodiments of the present disclosure, the predicting the write traffic prediction value of the (N+1)th new period based on the write traffic corresponding to each of the historical periods, includes: predicting the write traffic prediction value of the (N+1)th new period by a trend prediction model and based on the write traffic corresponding to each of the historical periods, wherein the trend prediction model includes a prophet model or a long-short term memory (LSTM) model.

According to one or more embodiments of the present disclosure, the invoking the capacity increment prediction quantization model and the load prediction quantization model based on the write traffic prediction value of the (N+1)th new period, to generate the target traffic scheduling policy of the (N+1)th new period, includes: invoking, by using a simulated annealing model, the capacity increment prediction quantization model and the load prediction quantization model based on the write traffic prediction value of the (N+1)th new period, to generate the target traffic scheduling policy of the (N+1)th new period.

According to one or more embodiments of the present disclosure, the invoking, by using the simulated annealing model, the capacity increment prediction quantization model and the load prediction quantization model based on the write traffic prediction value of the (N+1)th new period, to generate the target traffic scheduling policy of the (N+1)th new period, includes: determining a plurality of initial traffic scheduling solutions, wherein an initial traffic scheduling solution includes an initial write traffic proportion of each of the storage pools in the (N+1)th period; for each of the initial traffic scheduling solutions, invoking the capacity increment prediction quantization model and the load prediction quantization model by using a simulated annealing model based on the write traffic prediction value of the (N+1)th new period, to generate a local traffic scheduling solution of the (N+1)th new period, wherein a local scheduling proportion indicated by the local traffic scheduling solution is used to enable the load and the capacity increment of each of the storage pools to meet a local balance indicator; and selecting a local traffic scheduling solution with a highest local balance indicator from the local traffic scheduling solutions corresponding to the plurality of initial traffic scheduling solutions as the target traffic scheduling policy.

According to one or more embodiments of the present disclosure, the invoking, for each of the initial traffic scheduling solutions, the capacity increment prediction quantization model and the load prediction quantization model by using the simulated annealing model based on the write traffic prediction value of the (N+1)th new period, to generate the local traffic scheduling solution of the (N+1)th new period, includes: for each of the initial traffic scheduling solutions, adjusting, by using the simulated annealing model, the initial write traffic proportion of each of the storage pools in the (N+1) th period in the initial traffic scheduling solution, to acquire a plurality of simulated write traffic proportions of each of the storage pools in the (N+1) th period; for each of the simulated write traffic proportions, invoking the capacity increment prediction quantization model based on the simulated write traffic proportion and the write traffic prediction value, to predict the capacity increment of each of the storage pools in the (N+1)th period, and invoking the load prediction quantization model based on the simulated write traffic proportion and the write traffic prediction value, to predict the load of each of the storage pools in the (N+1)th period; and determining the first target write traffic proportion from the plurality of simulated write traffic proportions, wherein the first target write traffic proportion is the simulated write traffic proportion corresponding to the case wherein the capacity increment and the load of each of the storage pools in the (N+1)th period reach the local balance state.

According to one or more embodiments of the present disclosure, the generating the capacity increment prediction quantization model and the load prediction quantization model based on the write traffic corresponding to each of the historical periods, the write traffic proportion, the capacity increment and the load corresponding to each of the storage pools in each of the periods, includes: generating the capacity increment prediction quantization model based on the write traffic corresponding to each of the historical periods, the write traffic proportion and the capacity increment corresponding to each of the storage pools in each of the periods; and generating the load prediction quantization model based on the write traffic corresponding to each of the historical periods, the write traffic proportion and the load corresponding to each of the storage pools in each of the periods.

According to one or more embodiments of the present disclosure, the load includes one or more of a read request load, a write request load, and a query request load.

In a second aspect, according to one or more embodiments of the present disclosure, a traffic scheduling device for a distributed storage cluster is provided, including:
an acquiring unit, configured to acquire a write traffic corresponding to each of N historical periods in the distributed storage cluster, wherein the distributed storage cluster provides a storage service through a plurality of storage pools;
the acquiring unit is further configured to acquire a write traffic proportion, a capacity increment and a load corresponding to each of the storage pools in the distributed storage cluster in each of the historical periods;
a predicting unit, configured to predict a write traffic prediction value of an (N+1)th new period based on the write traffic corresponding to each of the historical periods;
a model generating unit, configured to generate a capacity increment prediction quantization model and a load prediction quantization model based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions; and
a scheduling unit, configured to invoke the capacity increment prediction quantization model and the load prediction quantization model based on the write traffic prediction value of the (N+1)th new period, to generate a target traffic scheduling policy of the (N+1)th new period, and controlling traffic scheduling of each resource pool based on a target scheduling proportion indicated by the target traffic scheduling policy, to enable the load and the capacity increment to meet a balance indicator.

According to one or more embodiments of the present disclosure, the predicting unit is configured to predict the write traffic prediction value of the (N+1)th new period based on the write traffic corresponding to each of the historical periods, and includes: predicting the write traffic prediction value of the (N+1)th new period by a trend prediction model and based on the write traffic corresponding to each of the historical periods, wherein the trend prediction model includes a prophet model or a long-short term memory (LSTM) model.

According to one or more embodiments of the present disclosure, the scheduling unit is configured to invoke the capacity increment prediction quantization model and the load prediction quantization model based on the write traffic prediction value of the (N+1)th new period, to generate the target traffic scheduling policy of the (N+1)th new period, and includes: invoking, by using a simulated annealing model, the capacity increment prediction quantization model and the load prediction quantization model based on the write traffic prediction value of the (N+1)th new period, to generate the target traffic scheduling policy of the (N+1)th new period.

According to one or more embodiments of the present disclosure, the scheduling unit is further configured to: determine a plurality of initial traffic scheduling solutions, wherein an initial traffic scheduling solution includes an initial write traffic proportion of each of the storage pools in the (N+1)th period; for each of the initial traffic scheduling solutions, invoke the capacity increment prediction quantization model and the load prediction quantization model by using a simulated annealing model based on the write traffic prediction value of the (N+1)th new period, to generate a local traffic scheduling solution of the (N+1)th new period, wherein a local scheduling proportion indicated by the local traffic scheduling solution is used to enable the load and the capacity increment of each of the storage pools to meet a local balance indicator; and select a local traffic scheduling solution with a highest local balance indicator from the local traffic scheduling solutions corresponding to the plurality of initial traffic scheduling solutions as the target traffic scheduling policy.

According to one or more embodiments of the present disclosure, the scheduling unit is further configured to: for each of the initial traffic scheduling solutions, adjust, by using the simulated annealing model, the initial write traffic proportion of each of the storage pools in the (N+1)th period in the initial traffic scheduling solution, to acquire a plurality of simulated write traffic proportions of each of the storage pools in the (N+1) th period; for each of the simulated write traffic proportions, invoke the capacity increment prediction quantization model based on the simulated write traffic proportion and the write traffic prediction value, to predict the capacity increment of each of the storage pools in the (N+1)th period, and invoke the load prediction quantization model based on the simulated write traffic proportion and the write traffic prediction value, to predict the load of each of the storage pools in the (N+1)th period; and determine the first target write traffic proportion from the plurality of simulated write traffic proportions, wherein the first target write traffic proportion is the simulated write traffic proportion corresponding to the case wherein the capacity increment and the load of each of the storage pools in the (N+1)th period reach the local balance state.

According to one or more embodiments of the present disclosure, the model generating unit is configured to generate the capacity increment prediction quantization model and the load prediction quantization model based on the write traffic corresponding to each of the historical periods, the write traffic proportion, the capacity increment and the load corresponding to each of the storage pools in each of the periods, and includes: generating the capacity increment prediction quantization model based on the write traffic corresponding to each of the historical periods, the write traffic proportion and the capacity increment corresponding to each of the storage pools in each of the periods; and generating the load prediction quantization model based on the write traffic corresponding to each of the historical periods, the write traffic proportion and the load corresponding to each of the storage pools in each of the periods.

According to one or more embodiments of the present disclosure, the load includes one or more of a read request load, a write request load, and a query request load.

In a third aspect, according to one or more embodiments of the present disclosure, an electronic device is provided, including: at least one processor and a memory.

The memory stores computer-executable instructions.

The at least one processor executes the computer-executable instructions stored in the memory, to enable the at least one processor to perform the traffic scheduling method for a distributed storage cluster according to the first aspect and various possible designs of the first aspect.

In a fourth aspect, according to one or more embodiments of the present disclosure, a computer-readable storage medium is provided. The computer-readable storage medium stores computer-executable instructions which, when executed by a processor, implement the traffic scheduling method for a distributed storage cluster according to the first aspect and various possible designs of the first aspect.

In a fifth aspect, according to one or more embodiments of the present disclosure, a computer program product is provided, including a computer program which, when executed by a processor, implements the traffic scheduling method for a distributed storage cluster according to the first aspect and various possible designs of the first aspect.

The above description is merely preferred embodiments of the present disclosure and an illustration of applied technical principles. Those skilled in the art should understand that the scope of disclosure involved in the present disclosure is not limited to the technical solutions formed by a specific combination of the above technical features, and shall also cover other technical solutions formed by any combination of the above technical features or equivalent features thereof without departing from the above disclosed concept, for example, a technical solution formed by replacing the above features with technical features with similar functions disclosed in the present disclosure (but not limited thereto).

In addition, although operations are depicted in a particular order, it should not be understood as that these operations are required to be performed in the specific order shown or in a sequential order. Under certain circumstances, multitasking and parallel processing may be advantageous. Similarly, although the above discussion includes several specific implementation details, these should not be construed as limitations to the scope of the present disclosure. Certain features that are described in the context of separate embodiments may also be implemented in combination in a single embodiment. In contrast, various features described in the context of a single embodiment may also be implemented in multiple embodiments individually or in any suitable sub-combination.

Although the subject matter has been described in language specific to structural features and/or logical actions of methods, it is to be understood that the subject matter defined in the appended claims is not necessarily limited to the specific features or actions described above. Rather, the specific features and actions described above are merely example forms for implementing the claims.

1. A method for traffic scheduling for a distributed storage cluster, comprising:
acquiring a write traffic corresponding to each of N historical periods in the distributed storage cluster, the distributed storage cluster providing a storage service through a plurality of storage pools;
acquiring a write traffic proportion, a capacity increment and a load corresponding to each of the storage pools in the distributed storage cluster in each of the historical periods;
predicting a write traffic prediction value of an (N+1)th new period based on the write traffic corresponding to each of the historical periods;
generating a capacity increment prediction quantization model and a load prediction quantization model based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions; and
invoking the capacity increment prediction quantization model and the load prediction quantization model based on the write traffic prediction value of the (N+1)th new period to generate a target traffic scheduling policy of the (N+1)th new period, and controlling traffic scheduling of each resource pool based on a target scheduling proportion indicated by the target traffic scheduling policy.

2. The method of claim 1, wherein predicting the write traffic prediction value of the (N+1)th new period based on the write traffic corresponding to each of the historical periods comprises:
predicting the write traffic prediction value of the (N+1)th new period by a trend prediction model and based on the write traffic corresponding to each of the historical periods,
wherein the trend prediction model comprises a prophet model or a long-short term memory (LSTM) model.

3. The method of claim 1, wherein invoking the capacity increment prediction quantization model and the load prediction quantization model based on the write traffic prediction value of the (N+1)th new period to generate the target traffic scheduling policy of the (N+1)th new period comprises:
invoking, by using a simulated annealing model, the capacity increment prediction quantization model and the load prediction quantization model based on the write traffic prediction value of the (N+1)th new period to generate the target traffic scheduling policy of the (N+1)th new period.

4. The method of claim 3, wherein invoking, by using the simulated annealing model, the capacity increment prediction quantization model and the load prediction quantization model based on the write traffic prediction value of the (N+1)th new period to generate the target traffic scheduling policy of the (N+1)th new period comprises:
determining a plurality of initial traffic scheduling solutions, wherein an initial traffic scheduling solution comprises an initial write traffic proportion of each of the storage pools in the (N+1)th period;
for each of the initial traffic scheduling solutions, invoking, by using the simulated annealing model, the capacity increment prediction quantization model and the load prediction quantization model based on the write traffic prediction value of the (N+1)th new period to generate a local traffic scheduling solution of the (N+1)th new period, wherein a local scheduling proportion indicated by the local traffic scheduling solution is used to enable the load and the capacity increment of each of the storage pools to meet a local balance indicator; and
selecting, from the local traffic scheduling solutions corresponding to the plurality of initial traffic scheduling solutions, a local traffic scheduling solution with a highest local balance indicator as the target traffic scheduling policy.

5. The method of claim 4, wherein for each of the initial traffic scheduling solutions, invoking, by using the simulated annealing model, the capacity increment prediction quantization model and the load prediction quantization model based on the write traffic prediction value of the (N+1)th new period to generate the local traffic scheduling solution of the (N+1)th new period comprises:
for each of the initial traffic scheduling solutions, adjusting, by using the simulated annealing model, the initial write traffic proportion of each of the storage pools in the (N+1)th period in the initial traffic scheduling solution, to obtain a plurality of simulated write traffic proportions of each of the storage pools in the (N+1 )th period;
for each of the simulated write traffic proportions, invoking the capacity increment prediction quantization model based on the simulated write traffic proportion and the write traffic prediction value of the (N+1)th new period to predict the capacity increment of each of the storage pools in the (N+1)th period, and invoking the load prediction quantization model based on the simulated write traffic proportion and the write traffic prediction value of the (N+1)th new period to predict the load of each of the storage pools in the (N+1)th period; and
determining a first target write traffic proportion from the plurality of simulated write traffic proportions, wherein the first target write traffic proportion is the simulated write traffic proportion corresponding to a case that the capacity increment and the load of each of the storage pools in the (N+1)th period reach a local balance state.

6. The method of claim 1, wherein generating the capacity increment prediction quantization model and the load prediction quantization model based on the write traffic corresponding to each of the historical periods, the write traffic proportion, the capacity increment and the load corresponding to each of the storage pools in each of the periods comprises:
generating the capacity increment prediction quantization model based on the write traffic corresponding to each of the historical periods, the write traffic proportion and the capacity increment corresponding to each of the storage pools in each of the periods; and
generating the load prediction quantization model based on the write traffic corresponding to each of the historical periods, the write traffic proportion and the load corresponding to each of the storage pools in each of the periods.

7. The method of claim 6, wherein the load comprises one or more of a read request load, a write request load, and a query request load.

8. An electronic device, comprising a processor and a memory, wherein
the memory stores computer-executable instructions which, when executed by the processor, cause the processor to:
acquire a write traffic corresponding to each of N historical periods in the distributed storage cluster, the distributed storage cluster providing a storage service through a plurality of storage pools;
acquire a write traffic proportion, a capacity increment and a load corresponding to each of the storage pools in the distributed storage cluster in each of the historical periods;
predict a write traffic prediction value of an (N+1)th new period based on the write traffic corresponding to each of the historical periods;
generate a capacity increment prediction quantization model and a load prediction quantization model based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions; and
invoke the capacity increment prediction quantization model and the load prediction quantization model based on the write traffic prediction value of the (N+1)th new period to generate a target traffic scheduling policy of the (N+1)th new period, and control traffic scheduling of each resource pool based on a target scheduling proportion indicated by the target traffic scheduling policy.

9. The electronic device of claim 8, wherein the computer-executable instructions that cause the processor to predict the write traffic prediction value of the (N+1)th new period based on the write traffic corresponding to each of the historical periods comprise instructions to cause the processor to:
predict the write traffic prediction value of the (N+1)th new period by a trend prediction model and based on the write traffic corresponding to each of the historical periods,
wherein the trend prediction model comprises a prophet model or a long-short term memory (LSTM) model.

10. The electronic device of claim 8, wherein the computer-executable instructions that cause the processor to invoke the capacity increment prediction quantization model and the load prediction quantization model based on the write traffic prediction value of the (N+1)th new period to generate the target traffic scheduling policy of the (N+1)th new period comprise instructions to cause the processor to:
invoke, by using a simulated annealing model, the capacity increment prediction quantization model and the load prediction quantization model based on the write traffic prediction value of the (N+1)th new period to generate the target traffic scheduling policy of the (N+1)th new period.

11. The electronic device of claim 10, wherein the instructions that cause the processor to invoke, by using the simulated annealing model, the capacity increment prediction quantization model and the load prediction quantization model based on the write traffic prediction value of the (N+1)th new period to generate the target traffic scheduling policy of the (N+1)th new period comprise instructions to cause the processor to:
determine a plurality of initial traffic scheduling solutions, wherein an initial traffic scheduling solution comprises an initial write traffic proportion of each of the storage pools in the (N+1)th period;
for each of the initial traffic scheduling solutions, invoke, by using the simulated annealing model, the capacity increment prediction quantization model and the load prediction quantization model based on the write traffic prediction value of the (N+1)th new period to generate a local traffic scheduling solution of the (N+1)th new period, wherein a local scheduling proportion indicated by the local traffic scheduling solution is used to enable the load and the capacity increment of each of the storage pools to meet a local balance indicator; and
select, from the local traffic scheduling solutions corresponding to the plurality of initial traffic scheduling solutions, a local traffic scheduling solution with a highest local balance indicator as the target traffic scheduling policy.

12. The electronic device of claim 11, wherein the instructions that cause the processor to, for each of the initial traffic scheduling solutions, invoke, by using the simulated annealing model, the capacity increment prediction quantization model and the load prediction quantization model based on the write traffic prediction value of the (N+1)th new period to generate the local traffic scheduling solution of the (N+1)th new period comprise instructions to cause the processor to:
for each of the initial traffic scheduling solutions, adjust, by using the simulated annealing model, the initial write traffic proportion of each of the storage pools in the (N+1)th period in the initial traffic scheduling solution, to obtain a plurality of simulated write traffic proportions of each of the storage pools in the (N+1 )th period;
for each of the simulated write traffic proportions, invoke the capacity increment prediction quantization model based on the simulated write traffic proportion and the write traffic prediction value of the (N+1 )th new period to predict the capacity increment of each of the storage pools in the (N+1)th period, and invoke the load prediction quantization model based on the simulated write traffic proportion and the write traffic prediction value of the (N+1)th new period to predict the load of each of the storage pools in the (N+1)th period; and
determine a first target write traffic proportion from the plurality of simulated write traffic proportions, wherein the first target write traffic proportion is the simulated write traffic proportion corresponding to a case that the capacity increment and the load of each of the storage pools in the (N+1)th period reach a local balance state.

13. The electronic device of claim 8, wherein the computer-executable instructions that cause the processor to generate the capacity increment prediction quantization model and the load prediction quantization model based on the write traffic corresponding to each of the historical periods, the write traffic proportion, the capacity increment and the load corresponding to each of the storage pools in each of the periods comprise instructions to cause the processor to:
generate the capacity increment prediction quantization model based on the write traffic corresponding to each of the historical periods, the write traffic proportion and the capacity increment corresponding to each of the storage pools in each of the periods; and
generate the load prediction quantization model based on the write traffic corresponding to each of the historical periods, the write traffic proportion and the load corresponding to each of the storage pools in each of the periods.

14. The electronic device of claim 13, wherein the load comprises one or more of a read request load, a write request load, and a query request load.

15. A non-transitory computer-readable storage medium, wherein the computer-readable storage medium stores computer-executable instructions which, when executed by a processor, causes the processor to:
acquire a write traffic corresponding to each of N historical periods in the distributed storage cluster, the distributed storage cluster providing a storage service through a plurality of storage pools;
acquire a write traffic proportion, a capacity increment and a load corresponding to each of the storage pools in the distributed storage cluster in each of the historical periods;
predict a write traffic prediction value of an (N+1)th new period based on the write traffic corresponding to each of the historical periods;
generate a capacity increment prediction quantization model and a load prediction quantization model based on the write traffic corresponding to each of the historical periods, the write traffic proportion, the capacity increment and the load corresponding to each of the storage pools in each of the periods, wherein the capacity increment prediction quantization model is configured to predict capacity increments of a resource pool caused by different scheduling proportions, and the load prediction quantization model is configured to predict loads caused by different scheduling proportions; and
invoke the capacity increment prediction quantization model and the load prediction quantization model based on the write traffic prediction value of the (N+1)th new period to generate a target traffic scheduling policy of the (N+1)th new period, and control traffic scheduling of each resource pool based on a target scheduling proportion indicated by the target traffic scheduling policy.

16. The non-transitory computer-readable storage medium of claim 15, wherein the computer-executable instructions that cause the processor to predict the write traffic prediction value of the (N+1)th new period based on the write traffic corresponding to each of the historical periods comprise instructions to cause the processor to:
predict the write traffic prediction value of the (N+1)th new period by a trend prediction model and based on the write traffic corresponding to each of the historical periods,
wherein the trend prediction model comprises a prophet model or a long-short term memory (LSTM) model.

17. The non-transitory computer-readable storage medium of claim 15, wherein the computer-executable instructions that cause the processor to invoke the capacity increment prediction quantization model and the load prediction quantization model based on the write traffic prediction value of the (N+1)th new period to generate the target traffic scheduling policy of the (N+1)th new period comprise instructions to cause the processor to:
invoke, by using a simulated annealing model, the capacity increment prediction quantization model and the load prediction quantization model based on the write traffic prediction value of the (N+1)th new period to generate the target traffic scheduling policy of the (N+1)th new period.

18. The non-transitory computer-readable storage medium of claim 17, wherein the instructions that cause the processor to invoke, by using the simulated annealing model, the capacity increment prediction quantization model and the load prediction quantization model based on the write traffic prediction value of the (N+1)th new period to generate the target traffic scheduling policy of the (N+1)th new period comprise instructions to cause the processor to:
determine a plurality of initial traffic scheduling solutions, wherein an initial traffic scheduling solution comprises an initial write traffic proportion of each of the storage pools in the (N+1)th period;
for each of the initial traffic scheduling solutions, invoke, by using the simulated annealing model, the capacity increment prediction quantization model and the load prediction quantization model based on the write traffic prediction value of the (N+1)th new period to generate a local traffic scheduling solution of the (N+1)th new period, wherein a local scheduling proportion indicated by the local traffic scheduling solution is used to enable the load and the capacity increment of each of the storage pools to meet a local balance indicator; and
select, from the local traffic scheduling solutions corresponding to the plurality of initial traffic scheduling solutions, a local traffic scheduling solution with a highest local balance indicator as the target traffic scheduling policy.

19. The non-transitory computer-readable storage medium of claim 18, wherein the instructions that cause the processor to, for each of the initial traffic scheduling solutions, invoke, by using the simulated annealing model, the capacity increment prediction quantization model and the load prediction quantization model based on the write traffic prediction value of the (N+1)th new period to generate the local traffic scheduling solution of the (N+1)th new period comprise instructions to cause the processor to:
for each of the initial traffic scheduling solutions, adjust, by using the simulated annealing model, the initial write traffic proportion of each of the storage pools in the (N+1)th period in the initial traffic scheduling solution, to obtain a plurality of simulated write traffic proportions of each of the storage pools in the (N+1 )th period;
for each of the simulated write traffic proportions, invoke the capacity increment prediction quantization model based on the simulated write traffic proportion and the write traffic prediction value of the (N+1 )th new period to predict the capacity increment of each of the storage pools in the (N+1)th period, and invoke the load prediction quantization model based on the simulated write traffic proportion and the write traffic prediction value of the (N+1)th new period to predict the load of each of the storage pools in the (N+1)th period; and
determine a first target write traffic proportion from the plurality of simulated write traffic proportions, wherein the first target write traffic proportion is the simulated write traffic proportion corresponding to a case that the capacity increment and the load of each of the storage pools in the (N+1)th period reach a local balance state.

20. The non-transitory computer-readable storage medium of claim 15, wherein the computer-executable instructions that cause the processor to generate the capacity increment prediction quantization model and the load prediction quantization model based on the write traffic corresponding to each of the historical periods, the write traffic proportion, the capacity increment and the load corresponding to each of the storage pools in each of the periods comprise instructions to cause the processor to:
generate the capacity increment prediction quantization model based on the write traffic corresponding to each of the historical periods, the write traffic proportion and the capacity increment corresponding to each of the storage pools in each of the periods; and
generate the load prediction quantization model based on the write traffic corresponding to each of the historical periods, the write traffic proportion and the load corresponding to each of the storage pools in each of the periods.
